(19) United States
(12) Patent Application Publication
(10) Pub. No.: US 2010/0029116 A1
(43) Pub. Date: Feb. 4, 2010

(54) Connector Assembly

(76) Inventor: Hans Simon, Unkel (DE)

Correspondence Address: SoCAL IP LAW GROUP LLP, 310 N. WESTLAKE BLVD. STE 120, WESTLAKE VILLAGE, CA, 91362, US

(21) Appl. No.: 12/533,986

(22) Filed: Jul. 31, 2009

(30) Foreign Application Priority Data
Aug. 1, 2008 (DE) 102008036128.3-34

(51) Int. Cl. H01R 13/28

(52) U.S. Cl. 439/290

(57) ABSTRACT

Connector assemblies are disclosed. The connector assembly (1) comprises a base body (2) having a surface (2a, 2b) and a front face (6) located in the direction of insertion, the base body having at least one contact tongue, each contact tongue having a connecting contact face (5) to form an electrical contact with a corresponding connector assembly. The connector assembly (1) further having at least one contact pocket (3) with a contact bottom (4), wherein the contact bottom (4) rises with respect to the surface (2a, 2b) of the base body (2), the contact pocket (3) having at least one opening (10).

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This application claims the benefit of priority to German Patent Application No. 102008036128.3-34, filed Aug. 1, 2008, the full contents of which are incorporated herein by reference in their entirety.

### BACKGROUND

1. Field

The invention relates to connector assemblies used to connect electronic components and devices as well as wires, cables and the like.

2. Description of the Related Art

Connector assemblies have differing shapes to achieve the same purpose in the electronic technology area. For example, an electrical contact element is known from German Patent DE 2216174A. Connector assemblies consisting of two different contact pairs are disclosed in GB1433382A, as well as in U.S. Pat. No. 3,065,448 A, U.S. Pat. No. 3,706.960A and U.S. Pat. No. 3,914,004A. The known connector assemblies have shapes, some of which are complicated and some of which are not, that are susceptible to failure, are not inherently safe, and are complicated and expensive to produce and use, especially because these are typically a pair of plug pin and plug sleeve.

Moreover the U.S. Pat. No. 2,787,774 discloses a connector assembly having a shaped contact bracket and a contact tongue. The contact bottom of the contact bracket is in parallel to the surface of the contact tongue. The contact tongue which is being pushed in line under the contact bracket, has a hemispherical protrusion. Fitting thereto, a hemispherical recess is formed in the contact bottom. Locking of the connector assembly merely occurs by friction of the two surfaces of the hemispheres.

Referring to U.S. Pat. No. 3,065,451, a connector assembly is shown which comprises a plug pin and a sleeve. The plug pin has a contact tongue with retraction protection. The sleeve has a contact bracket and a receiver for the retraction protection.

U.S. Pat. No. 2,406,895 discloses a connector assembly having a contact bracket and a contact tongue, wherein the contact tongue is formed bifurcated. A contact bottom of the contact bracket is arranged in parallel to the surface of the contact tongue.

U.S. Pat. No. 3,514,740 discloses a connector assembly having a contact tongue and a pair of pressure brackets. Both components of the connector assembly are formed of similar type. The contact tongue has a hemispherical protrusion, which is guided by the two pressure brackets and allows an aligned mating of two components of similar type. The contact pressure is created by the pressure brackets when bent up upon insertion.

### DESCRIPTION OF THE DRAWINGS

In the following the invention is described in reference to the embodiments shown in the drawings. In the description, in the claims and in the drawings, the terms used in the list of reference numerals below and dedicated reference numerals are used. In the drawings

FIG. 1 shows a connector assembly having a contact pocket, in a perspective view from above;

FIG. 2 shows a connector assembly, axially rotated about 180°, according to FIG. 1 in a perspective view;

FIG. 3 shows two connector assemblies inserted into each other in perspective view;

FIG. 4 shows a side view of two connector assemblies inserted into each other according to FIG. 1;

FIG. 5 shows an axial cross section of two connector assemblies inserted into each other according to FIG. 2;

FIG. 6 shows two connector assemblies, which are connected to an end of a conducting band of material;

FIG. 7 shows a splitter plug with two connector assemblies according to FIG. 1 in a perspective view;

FIG. 8 shows a connector assembly with a side wall and laterally deflected latching hooks in a perspective view;

FIG. 9 shows a connector assembly corresponding to the connector assembly of FIG. 8 in a perspective view;

FIG. 10 shows a connector assembly with side wall and vertical deflected latching hooks in a perspective view;

FIG. 11 shows a connector assembly corresponding to the connector assembly of FIG. 10;

FIG. 12 shows a connector assembly having a stamped front contact bridge with a connector assembly built up as a flat or planar connector tongue;

FIG. 13 shows a connector assembly having a formed front contact bridge with a connector assembly built up as a flat or planar connector tongue;

FIG. 14 shows a connector assembly having a formed front contact bridge connected with a connector assembly built up as a flat or planar connector tongue;

FIG. 15 shows a connector assembly having a conductor connection at a side face 90° with respect to the direction of insertion;

FIG. 16 shows two connector assemblies plugged together having a conductor connection at a side face 90° with respect to the direction of insertion;

FIG. 17 shows a connector assembly having crimping claws located in the direction of insertion in a perspective top view;

FIG. 18 shows a connector assembly having crimping claws located in the direction of insertion in a perspective view from the bottom, and

FIG. 19 shows two connector assemblies plugged together having crimping claws located in the direction of insertion.

### DETAILED DESCRIPTION

The connector assemblies described herein have a mutually enclasping connection that is simple, robust, inherently safe that may be made for a relatively low cost and to which conducting bands and lead ends may be connected.

A connector assembly comprises a base body of electrically conducting material with at least a surface and a front face located in the direction of insertion. Depending on the shape of the base body, a surface is, for example, any side surface of a cuboid base body or the shell of a cylinder. At the front face of the inventive connector assembly, a contact tongue is arranged. In this embodiment, the contact tongue of the contact assembly is configured with its surface in parallel to the respective surface of the connector assembly, in particular aligned in the same plane. This configuration simplifies the manufacturing process and reduces manufacturing costs. Further, the connector assembly comprises at least one connecting contact surface by which an electrical contact can be made.

The connector assembly described herein has at least one contact pocket arranged at least one surface of the base body having a contact bottom. The contact bottom rises in one direction with respect to the respective surface. The contact pocket is formed with at least one opening. By way of the inclination of the contact pocket with respect to the surface, the contact tongue of a corresponding connector assembly which is inserted in the contact pocket parallel to the surface becomes tensioned, such as by a force fitting. The tensioning allows the contact tongue of the connector assembly to be fixedly connected to the corresponding connector assembly orthogonally to the surface. Thus, a mechanically extremely strong connection of at least two connector assemblies is produced. Therein, the electrical contact resistance is very low and is additionally reduced in an atypical manner by an increase of the temperature, because the tension in the connector assembly increases from heating, which increases the connecting force. This allows high nominal currents, which ensures a that the connector assembly is suitable for many applications.

The connector assembly is connectable with a corresponding part on a second conductor assembly which has at least one contact pocket and at least one contact tongue as well. The contact pocket of the connector assembly is formed so that it can accommodate the contact tongue of the corresponding part on a second conductor assembly. The contact tongue of the connector assembly is formed so that this is insertable into the contact pocket of the corresponding part on a second conductor assembly. When the connector assembly and one respective corresponding part with surfaces lying parallel are inserted into each other, the contact tongue is deflected from its original position because of the different angular positioning of contact bottom and contact tongue with respect to the surface. Because of this deflection, a resisting force is generated which affects a contact pressure of each contact tongue on the associated contact bottom. Because of the high contact pressure, a mechanically robust connection of the connector assembly with the corresponding part is provided. In this way, the connector assemblies have a mutually enclasping connection. Because of this pressure, the respective areas between the contact tongue and the contact pocket are pressed upon each other. Because of the contact pressure and the relatively large faces pressed upon each other, a low contact resistance is obtained which allows high nominal currents and results in lower current loss. As mentioned above, expansion resulting from an increase in temperature while in operation increases the contact pressure.

In a further embodiment, the width of a contact pocket is slightly larger then the width of the associated contact tongue. The contact tongue is aligned with the faces of the contact pocket. The connector assembly has a recess corresponding to the projection of the contact bottom on the respective surface of the connector assembly. This embodiment allows mating two connector assemblies identical in construction which are axially rotated about 180° with respect to each other. The respective contact tongues are deflected from their original position by the respective surfaces of the contact bottom. Thereby, an electrically conducting contact which has a particularly large area and is force fitted, is generated by the interlinking connector assemblies. The mechanical fit or strain which is generated by the interlinking insertion, is further increased by an increase of temperature. Commonly, there is an increase in contact resistance resulting from an increase in temperature; however, in the connector assembly described herein, the contact resistance remains constant when the temperature increases or decreases.

An embodiment of the connector assembly has exactly one contact pocket and exactly one corresponding contact tongue. This embodiment is suited especially for connecting of wires and lazing, respectively. Alternatively, a design of a connector assembly with several contact tongues and, correspondingly, with several contact pockets aligned with the contact tongues, allows the contacting with individual corresponding connector assemblies. In this way, current distribution or splitting may be achieved.

A connector assembly with several contact pockets and contact tongues may be connected to corresponding connector assemblies also having several contact pockets and contact tongues. Thereby a larger current flow (nominal current) is provided. A corresponding connector assembly system can be used in a modular manner according to particular implementation requirements.

Preferably, the contact tongue can be provided with at least one latch. The latch interacts with a recess provided inside the contact pocket, which recess may have an edge in the direction of insertion. Because of the design of the latch, the two corresponding connector assemblies are difficult to separate from each other, and are better protected against an unwanted disconnection. This design is particularly effective if both of the corresponding connector assemblies are provided with respective latches, because both of them are active at the same time. The latches may be in the form of a bump, burl or protrusion, i.e. of a hemisphere, a feather key, or the like. Depending on the design of the latches in connection with the design of the edge shape, two corresponding connector assemblies can be detachably or non-detachably locked. As such, two connector assemblies form a mutually enclasping connection.

In a further embodiment, a connector assembly comprises a base body of electrical conductive material with at least one surface and one front face located in the direction of insertion. A surface is, depending on the shape of the base body, for example any, side surface of a cuboid structure or the shell of a cylinder. At the front face of the connector assembly, at least one contact bridge is arranged. This is characterized by having a bridge lower edge which is substantially in parallel to the associated surface and is spaced there from. Between the bridge lower edge and the surface, a flat or planar connector tongue is insertable into the contact pocket. This embodiment allows the connection with conventional connector assemblies having a planar connector tongue.

As set forth herein, the connector assembly comprises at least one contact pocket formed on at least one surface of the base body and having a contact bottom. The contact bottom rises in one direction with respect to the respective surface. The contact pocket has at least one opening. By way of the inclination of the contact pocket with respect to the surface, a contact tongue inserted in parallel to the surface into the contact pocket builds up a tension with the contact bridge located in the inserting direction in front of the contact pocket. In this way, a mechanically robust connection of at least two connector assemblies is produced. As such, the connector assembly has a mutually enclasping connection. The transition resistance of the connection is very low and is further reduced in an atypical manner by an increase of temperature which is caused inter alia by the current flow itself. This allows high nominal currents which assures that the connector assemblies are suitable for numerous applications.

In a particularly advantageous manner, the contact bottom rises with respect to the surface in the direction of insertion and forms an opening between the contact bottom and the surface. The resulting opening resulting points in the direction of insertion. This has the advantage that an insertion into each other “from the front” of a corresponding pair of connectors is allowed.

Preferably, at least a conductor connection is arranged opposite of the front face of the base body to provide contact with an electrical conductor. As an alternative thereto, the conductor connection can be arranged depending on expediency also laterally of the base body, for example under 90° to the direction of insertion. Thereby, an inherently safe strain relief is realized. An increased intrinsic safety of the connector assembly can be achieved thereby, as the conductor connection lies in the direction of insertion. In this embodiment, the conductor connection may be in a plane spaced apart from the surface of the connector assembly, so as not to prevent the insertion of two connector assemblies into each other. Because the conductor connection lies in the direction of insertion, a force acts on the conductor in the direction of insertion which contributes to an increased interlinking of two connector assemblies.

The conductor can be formed so that the contacting of a conductor can be made by applying pressure. Especially suited for this purpose is crimp-contacting. Therefore, crimping claws may provided as a conductor connection for pressure-fitting the connector assembly to the ends of electrical lines, wires, and especially strands. Crimp contacts are in widespread use and are known for their simple handling and their temperature stable connections.

In another embodiment, the connector assembly may be connected by form-fitting and/or by material engagement by a conductor connection to a device wall, a contact body, a band or a ground bus. The connector assembly may also be connected with metal blanks and parts formed out of metal.

In another embodiment, the connector assembly is made of strip stock. In this embodiment, the contact pocket can be formed out of the base body. The strip stock may be cold or hot formable. This embodiment is especially robust, cost effective and relatively simple to manufacture.

In a further embodiment, the connector assembly includes sidewalls. The sidewalls of the connector assembly may be planar (i.e., flat), inclined, and profiled. The sidewalls may be formed as a guide with a stopper and/or have latching tongues. When additional side walls are used, the cross section of the connector assembly is larger. This embodiment is especially useful as an insulation and catch mechanism of insulating case compartments.

Further advantages, features and applications of the connector assembly will become apparent from the following description in reference to the embodiments shown in the drawings.

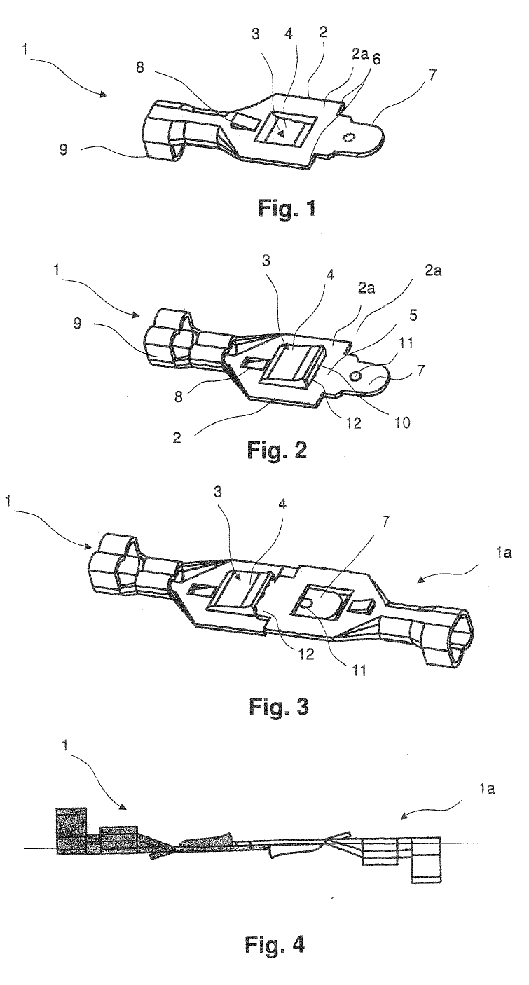

FIG. 1 shows a perspective view of a connector assembly 1 produced of strip stock. The connector assembly 1 has a base body 2 with a surface 2a and a front face 6 located in the direction of insertion, to which a contact tongue 7 is provided. Opposite to the front face 6, a conductor connection is indicated in the form of crimping claws 9. From the base body 2 a contact pocket 3 is formed with a contact bottom 4, wherein the distance from the surface 2a to the contact bottom increases in the direction of insertion. Because the contact pocket 3 in this case is formed out of the base body 2, a recess of the base body 2 forms the size and shape of the projection of the contact bottom 3 on the surface 2a. The latching edge 12 (shown in FIG. 2) is generated in the direction of insertion by forming. Further, the connector assembly 1 has a latching hook 8. Thereby the connector assembly 1 can be fixed in a respective box of a corresponding matching part of the connector assembly.

FIG. 2 shows a connector assembly 1 as in FIG. 1 in a position rotated axially about 180°. The connector assembly 1 comprises a contact pocket 3 having an opening 10 pointing in the direction of insertion. At the front face 6, a contact tongue 7 is arranged on which a locking protrusion 11 is formed. The locking protrusion 11, after inserting of the contact tongue 7 in a connector assembly 1a similar in construction, arrives at the recess of the base body 2 and snaps there into, see in particular FIG. 3.

FIG. 3 shows a connector assembly 1 plugged together with a connector assembly 1a of a similar construction in the contact pocket 3 of which the contact tongue 7 of the connector assembly 1a is contained, whereby, at the same time, the contact tongue 7 of the connector assembly 1 is inserted into the contact pocket 3 of the connector assembly 1a. The locking protrusions 11 snap respectively behind the respective latching edges 12. Because of the locking protrusions 11 in association with the latching edges 12, the intrinsic safety of the connector assembly is improved. This drawing shows the mutually enclasping connections of the connector assembly.

FIG. 4 shows plugged together connector assemblies 1 and 1a in a side view, formed as in FIG. 3. The parallel location of the surfaces of the two connector assemblies 1 and 1a may be seen in this drawing.

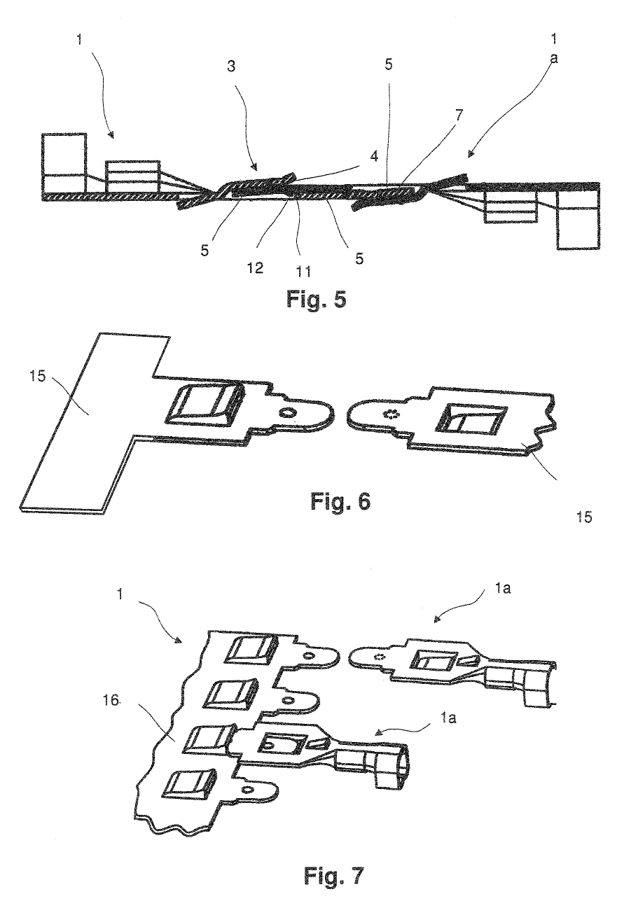

FIG. 5 shows a longitudinal section through the connector assemblies 1 and 1a of FIG. 4 contact tongues 7 which are interlinked/latched in the contact pockets 3 by the rising level of the contact bottoms 4. A contact is made between the contact bottom 4 of the first connector assembly 1 and the contact tongue 7 of the second contact assembly 1a in a similar way. A further contact is established by the surfaces lying between the respective contact pocket 3 and contact tongue 7. Beyond establishing an electrically conductor connection, three connecting contact surfaces 5 are additionally pressed together by the return spring effect of the contact tongue 7, whereby the return spring capability of the strip stock is not overstrained. When the temperature increases, no loss of the contact pressure occurs, rather the tension or force will increase due to the increase of the temperature and the contact resistance will be reduced, and increased intrinsic safety will be achieved.

FIG. 6 shows a connector assembly 1 formed on a band end 15. This embodiment of connection is especially suited for ground wires, case walls and the like. Further, plug-in cards are connectable with a box.

FIG. 7 shows a connector assembly 1 formed on a splitter plate 16. Several contact pockets and respectively dedicated contact tongues are shown. This embodiment of a connector assembly exhibits a splitter function which may be used for current distribution. Several connector assemblies 1a are pluggable into the connector assembly 1, as shown in FIG. 1.

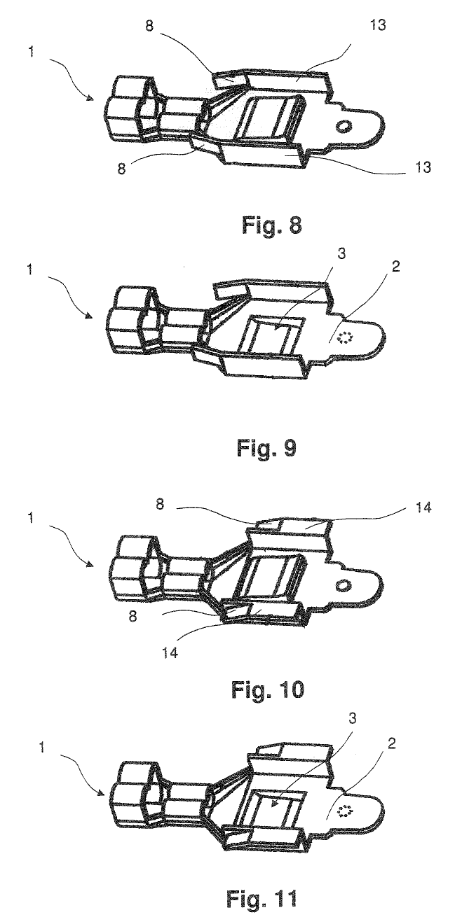

FIG. 8 shows a connector assembly 1 of FIG. 1 having lateral angled side walls 13 and latching hooks 8 connected laterally therewith. The side walls increase the stability of the connector assembly and enlarge the cross section of the connector assembly.

FIG. 9 shows a connector assembly of FIG. 8, having a contact pocket 3 built up at the surface 2b lying at the bottom surface of the base body 2.

FIGS. 10 and 11 show connector assemblies of FIG. 8 and FIG. 9. In these drawings, angled side walls 14 are built up at the sides of the base body. The angled side walls 14 have a face vertical to the surface 2a and a face pointing outwards and parallel to the surface 2a. A latching hook 8 is joined to the surface which is in parallel to the surface 2a.

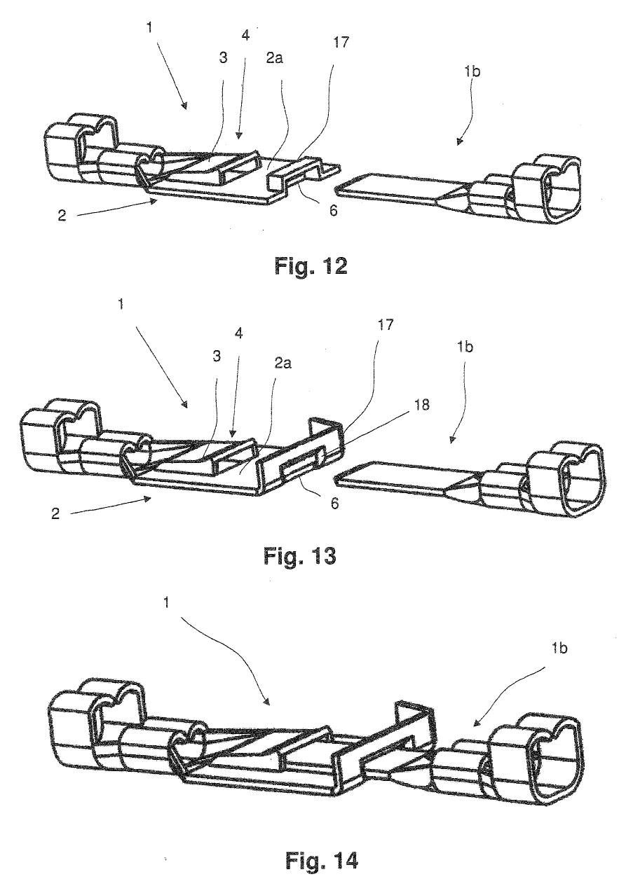

FIG. 12 shows a connector assembly with contact pocket 4 having a contact bridge on its frontal face 6. Further, a complementary commercial connector assembly 1b having flat or planar connector tongue, is shown. The complementary connector assembly 1b having a flat or planar connector tongue is inserted below the contact bridge in parallel to the surface 2a of the connector assembly 1, and it is inserted into the contact pocket 3. Thereby the contact bottom 4 slopes obliquely with respect to the surface 2a, and the connector assembly 1b with the flat or planar connector tongue is positioned, force fitted or wedged between the contact bridge 17 and the contact pocket 4. Both contact faces and the surface between contact pocket 4 and contact bridge 17 each form a connecting contact face 5. The contact bridge 17 is formed out of the base body 2.

FIG. 13 shows a connector assembly 1 with a contact pocket 4 and a contact bridge 17, as well as a complementary connector assembly 1b with a flat or planar connector tongue. The connector assembly 1 is made of strip stock. The contact bridge 17 is built at the front face 6 of the connector assembly 1. The contact bridge 17 is bent up out of the base body 2. Through the opening under the contact bridge 17, the connector assembly 1b with flat or planar connector tongues is inserted into the contact pocket 4. Additionally, the connector assembly 1 has a guiding edge 18 on the contact bridge 17. As in FIG. 4 the flat or planar connector tongue connector assembly 1b is positioned, force fitted or wedged between contact bridge 17 and contact pocket 4 so that the contact bottom 4 slopes obliquely to the surface 2a. Both contact faces and the surface between contact pocket 4 and contact bridge 17 function respectively as a connecting contact face 5.

FIG. 14 shows a connector assembly 1 with a connector assembly 1b with a flat or planar connector tongue as in FIG. 13, where the connector assembly 1b with a flat or planar connector tongue is inserted in the contact pocket 4 and is positioned below the contact bridge 17.

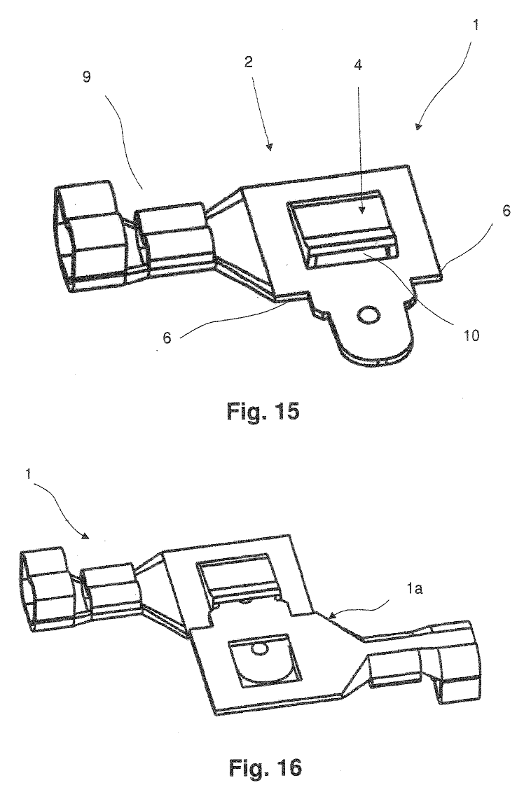

FIG. 15 shows, in perspective view, a connector assembly 1 with a contact pocket 4, the opening 10 of which lies in a direction of insertion. In this embodiment, the conductor connection, which is formed as a crimp connection, lies at 90° with respect to the front face and to the direction of insertion.

FIG. 16 shows two connector assemblies 1, 1a of FIG. 15 plugged together. It can be seen in this drawing that this arrangement increases the intrinsic safety of the connector assembly. Pulling at a wire mounted at the conductor connection acts orthogonally to the direction of insertion. Thereby, no force results from the pulling action that would loosen the connector assemblies from each other. To attempt to loosen or break the connection, force has to be applied in the orthogonal direction.

FIG. 17 shows a connector assembly 1 with a base body 2 and a surface 2a as well as a front face 6 and a contact tongue 7 joined thereto. Moreover, the connector assembly 1 shows a contact pocket 3 formed at the surface 2a, the case being open in the direction of insertion. Further, the connector assembly 1 shown in FIG. 17, has a conductor connection in the form of crimping claws 9. In this embodiment, the crimping claws 9 are positioned in the direction of insertion in a plane spaced apart in parallel to the surface 2a. The crimping claws 9 are connected to the side faces of the base body 2.

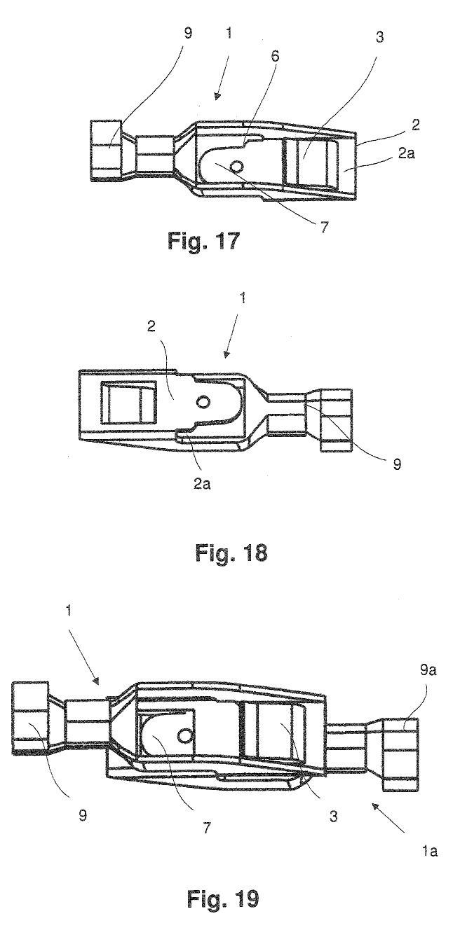

FIG. 18 shows a connector assembly 1 of FIG. 17 rotated axially about 180°. In this view, it can be seen that the crimping craws are positioned in a plane spaced apart from the surface 2a of the base body 2.

FIG. 19 shows two connector assemblies 1, 1a of FIG. 17 or FIG. 18 of the same construction. This drawing shows two connector assemblies 1, 1a plugged together, even though the crimping claws 9, 9a are positioned in a direction of insertion. This embodiment has the advantage that a pulling action on the wire fixed to the crimping claws 9, 9a causes a force in the direction of insertion. By this force acting in the direction of insertion, the connector assemblies 1, 1a are further plugged together by the pulling action. Thereby, the intrinsic safety of the connector assembly is increased. As described above, the contact tongue 7 and contact pocket 3 of the connector assemblies 1, 1a also interconnect here.

The connector assemblies described herein are space saving, inherently safe, and may be produced at low price, is provided. The connector assemblies described herein achieve a lower contact resistance as compared to known connector assemblies, and are resilient across a wide range of temperatures because of the interlinking connection.

List of Reference Numerals

1 connector assembly

1a connector assembly

1b connector assembly with flat or planar connector tongue

2 base body

2a surface

2b surface

3 contact pocket

4 contact bottom

5 connecting contact face

6 front face

7 contact tongue

8 latching hook

9 crimping claws

10 opening

11 locking protrusion

12 latching edge

13 side wall

14 angled side wall

15 band end

16 splitter plate

17 contact bridge

18 guiding edge

It is claimed:

1. A connector assembly comprising: a base body (2) having a surface (2a, 2b) and a front side (6) located in a direction of insertion, the base body having at least one contact tongue (7) each contact tongue having a connecting contact face (5) to produce an electrical contact when inserted into a corresponding connector assembly, characterized in that a at least one contact pocket (3) with a contact bottom (4) is provided the surface (2a, 2b) of the base body (2), wherein the contact bottom (4) rises with respect to the surface (2a, 2b) of the base body (2), the contact pocket (3) having an opening (10).

2. The connector assembly of claim 1 wherein the contact tongue (7) of the corresponding connector assembly (1a) is insertable into the contact pocket (3) of the connector assembly (1) to conduct an electrical contact.

3. The connector assembly of claim 1 wherein a contact pocket width is at least as large as a contact tongue width, whereby the contact tongue (7) of the connector assembly is insertable into the contact pocket (3) of the corresponding connector assembly.

4. The connector assembly of claim 1 having exactly one contact pocket (3) and exactly one contact tongue (7).

5. The connector assembly of claim 1 having a plurality of contact pockets (3) and a plurality of contact tongues (7).

6. The connector assembly of claim 1 having at least one latch (11) on the contact tongue (7).

7. The connector assembly of claim 1 further comprising a conductor connection (9, 15) on the base body (2) positioned opposite the contact tongue (7).

8. The connector assembly of claim 7 wherein the conductor connection is connectable by one of form-fitting with further electrically conductive elements or by material engagement with further electrically conductive elements.

9. The connector assembly according to claim 1 wherein the base body (2) has a recess which matches, in position, form and size, to the projection of the contact bottom (4) onto the base body (2).

10. The connector assembly according to claim 1 wherein the connector assembly (1) is made of strip stock.

11. The connector assembly according to claim 10 wherein the strip stock is one selected from the group including cold or warm workable.

12. The connector assembly according to claim 1 having two side walls (13, 14) on sides of the base body (2) along the direction of insertion.

13. A connector assembly (1) comprising a base body (2), the base body having at least one contact bridge (17) located in a direction of insertion, the base body having a contact pocket (3) with a contact bottom (4), wherein the contact bottom (4) protrudes with respect to a surface (2a) of the base body (2), the contact pocket (3) having an opening (10), the surface of the base body to form an electrical contact with a contact tongue of a complementary connector assembly, the contact tongue of the complementary connector assembly passing through the contact bridge, entering the contact pocket, and forming a force fit in the contact packet.

14. The connector assembly of claim 13 wherein the contact bottom (4) and the surface (2a) of the base body (2) form an opening (10) in the direction of insertion.

15. The connector assembly of claim 13 further comprising a conductor connection (9, 15) on the base body (2) positioned opposite the contact bridge (17).

16. The connector assembly according to claim 15 wherein the conductor connection (9) allows a connection to the ends of electrical lines by applying pressure.

17. The connector assembly according to claim 15 wherein the conductor connection is connectable by one of form-fitting with electrically conductive elements or by material engagement with electrically conductive elements.

18. The connector assembly according to claim 13 wherein the base body (2) has a recess which matches in position, form and size the contact bottom (4).

19. The connector assembly according to claim 13 wherein the connector assembly (1) is produced of strip stock.

20. The connector assembly according to claim 13 having two side walls (13, 14) on sides of the base body (2) along the direction of insertion.
